(19) United States
(12) Patent Application Publication
(10) Pub. No.: US 2006/0286969 A1
(43) Pub. Date: Dec. 21, 2006

(54) Personal authentication system, apparatus and method

(75) Inventors: Eli Talmor, Haifa (IL); Rita Talmor, Haifa (IL); Alon Talmor, Haifa (IL)

Correspondence Address: Martin Moynihan;Prtsi, PO Box 16446, Arlington, VA, 22215, US

(73) Assignee: SentryCom Ltd., HAIFA (IL)

(21) Appl. No.: 10/547,347

(22) PCT Filed: Mar. 4, 2004
(86) PCT No.: PCT/IL04/00218

§ 371 Date: Sep. 1, 2005

(30) Foreign Application Priority Data
Mar. 4, 2003 (IL) 154733

(51) Int. Cl. H04M 1/64; H04M 15/06; H04M 3/42

(52) U.S. Cl. 455/415; 379/67.1; 379/142.01

(57) ABSTRACT

A remote authentication system for authenticating remotely located users of authenticable communication devices, comprises a device authenticator for obtaining an authenticated device identity, a user authenticator for obtaining a personal biometric measure from voice transmitted from the communication device by the user, and a database of biometric measures and device identities for allowing the personal biometric measure received at the user authenticator to be related via the communication device identity to a prestored personal biometric measure of a legitimate user of the authenticable communication device, thereby to authenticate the user. A preferred biometric measure is a voice print and a preferred communication device is a mobile telephony device, whose device identity or CLI is authenticated upon log-in. Authentications can be user initiated or center initiated and do not require specialized equipment at the point of authentication.

### FIELD AND BACKGROUND OF THE INVENTION

The present invention relates to a personal authentication system, method and apparatus, and, more particularly, but not exclusively to a personal authentication system, method and apparatus that is entirely portable and does not rely on specialist equipment being available at the point of use.

Authentication is widely used today for financial transactions for gaining entry to buildings or secure areas and for numerous other purposes. Authentication systems have in the past relied on physical signatures, but these can be forged. Electronic locks which rely on a user entering a numerical code are also a form of authentication. Credit cards may carry the photograph of the legitimate holder.

Other authentication systems rely on biometrics, personally unique properties that are unique to an individual. These include electronic voice-scan which obtains a voice print, every person having a unique voice print, an automatic fingerprint scan, an iris scan, a facial scan and electronic signature scan. The disadvantage of biometrics is that it requires specialist electronic equipment, for example retinal scan equipment, at the point or place at which the person to be authenticated is located, hereinafter the point of authentication. This is expensive and, with the exception of voice print, limits authentication to point type applications. In particular, “On the move” authentication is ruled out. For example it is impossible to provide a biometrics based authentication scheme for road tolls if a requirement is that the driver is not stopped.

Voice verification, which is also known as voice authentication, voice pattern authentication, speaker identity verification and voice print, is one method that can be used to provide the speaker authentication. The terms voice verification, voice print, and voice authentication are interchangeably used hereinbelow. Techniques of voice verification have been extensively described in U.S. Pat. Nos. 5,502,759; 5,499,288; 5,414,755; 5,365,574; 5,297,194; 5,216,720; 5,142,565; 5,127,043; 5,054,083; 5,023,901; 4,468,204 and 4,100,370, all of which are incorporated by reference as if fully set forth herein. These patents describe numerous methods for voice verification.

Voice authentication seeks to identify the speaker based solely on the spoken utterance. For example, a speaker's presumed identity may be verified using feature extraction together with pattern matching algorithms, wherein pattern matching is performed between features of a digitized incoming voice print and those of previously stored reference samples. Features used for speech processing involve, for example, pitch frequency, power spectrum values, spectrum coefficients and linear predictive coding, see B. S. Atal (1976) Automatic recognition of speakers from their voice. Proc. IEEE, Vol. 64, pp. 460-475; which is incorporated by reference as if fully set forth herein.

Alternative techniques for voice identification include, but are not limited to, neural network processing, comparison of a voice pattern with a reference set, password verification using, selectively adjustable signal thresholds, and simultaneous voice recognition and verification.

State-of-the-art feature classification techniques are described in S. Furui (1991) Speaker dependent—feature extraction, recognition and processing techniques. Speech communications, Vol. 10, pp. 505-520, which is incorporated by reference as if fully set forth herein.

Text-dependent speaker recognition methods rely on analysis of predetermined utterance, whereas text-independent methods do not rely on any specific spoken text. In both case, however, a classifier produces the speaker's representing metrics which is thereafter compared with a preselected threshold. If the speaker's representing metrics falls below the threshold the speaker identity is confirmed and if not, the speaker is declared an impostor.

The relatively low performance of voice verification technology has been one main reason for its cautious entry into the marketplace. The “Equal Error Rate” (EER) is a calculation algorithm which involves two parameters: false acceptance (wrong access grant) and false rejection (allowed access denial), both varying according the degree of secured access required, however, as shown below, exhibit a tradeoff therebetween. State-of-the-art voice verification algorithms (either text-dependent or text-independent) have EER values of about 2%.

By varying the threshold for false rejection errors, false acceptance errors change as graphically depicted in FIG. 1 of J. Guavain, L. Lamel and B. Prouts (March, 1995) LIMSI 1995 scientific report, which is incorporated by reference as if fully set forth herein. In this Figure are five plots which correlate between false rejection rates (abscissa) and the resulting false acceptance rates for voice verification algorithms characterized by EER values of 9.0%, 8.3%, 5.1%, 4.4% and 3.5%. As mentioned above there is a tradeoff between false rejection and false acceptance rates, which renders all plots hyperbolic, wherein plots associated with lower EER values fall closer to the axes.

Thus, by setting the system for too low false rejection rate, the rate of false acceptance becomes too high and vice versa.

Various techniques for voice-based security systems are described in U.S. Pat. Nos. 5,265,191; 5,245,694; 4,864,642; 4,865,072; 4,821,027; 4,797,672; 4,590,604; 4,534,056; 4,020,285; 4,013,837; 3,991,271; all of which are incorporated by reference as if fully set forth herein. These patents describe implementation of various voice-security systems for different applications, such as telephone networks, computer networks, cars and elevators.

However, none of these techniques provides the required level of performance, since when a low rate of false rejection is set, the rate of false acceptance becomes unacceptably high and vice versa.

Voice prints can be taken remotely, for example over a telephone network. An example of obtaining a voice print over a telephone network is given in U.S. Pat. No. 5,913,196 to the present inventors, the content of which is hereby incorporated by reference. The cited patent discloses a method of improving the reliability of voice print recognition by using two independent algorithms for obtaining voice prints and only authenticating if both algorithms give a positive result. U.S. Pat. No. 6,510,415 to the present inventors provides additional reliability by comparing the incoming voice print with a plurality of stored voice prints which includes that of the presumed user. The authentication is made if one of the compared voice prints gives a significantly higher similarity value than any of the others, rather than using an absolute measure of similarity, and therefore line distortions, background noise and the like are discounted.

US Patent Application Publication No. 2003/1035740 A1, to the present inventors provides a system for remote authorization over a computer network in which a data form allows a user to input a user identity, a PIN (personal identification number) and voice, using web-based processing More particularly, the patent is about using PC for Remote Access and Online Transaction and Secure E-Mail Furthermore, simply taking a voice print from a remote location is not going to enable any activity at the remote location in the absence of additional apparatus at that location which can be enabled. That is to say, what do you do once you have authorized the caller? Furthermore, how does the remote center providing authorization know where the caller is and therefore what equipment to provide the authorization to?

An alternative possibility for authentication is based on mobile telephones. Mobile telephones have a secure log-on procedure based on electronic signatures so that a party can be very sure that when a particular caller line identification (CLI) appears, it is the corresponding mobile telephone that is being used. A caller Number ID but without authentication exists for regular telephones as well. However mobile telephones can be lent out, cloned or stolen. There is no guarantee that the user is the legitimate user, and thus there has been consumer reluctance to use authentication based on the CLI for any purpose other than the regular use of the mobile telephone for making calls. Again, even if the mobile telephone is used in the authentication procedure, the remote center has no idea where the telephone is and therefore cannot know what equipment to enable.

Prior art U.S. Pat. No. 5,903,830 describes apparatus and a method intended to increase transaction security. A user presents his credit card at the Point-of-Sale, say at a Department Store or ATM. Then the Transaction Server of the Credit Card Company initiates a telephone call to the mobile number of the user. The user answers the call and authorizes the transaction. Such an approach has an operational flaw—namely the Transaction Server must preserve the communication link with the Point-of-Sale and the user until the authorization is completed. This slows the system considerably and results in low concurrency performance.

There is thus a widely recognized need for, and it would be highly advantageous to have, a user authentication system devoid of at least some of the above limitations.

### SUMMARY OF THE INVENTION

According to one aspect of the present invention there is provided a remote authentication system for authenticating remotely located users of authenticable communication devices, comprising:

a device authenticator for obtaining an authenticated device identity of the authenticable communication device,

a user authenticator for obtaining a personal biometric measure from voice-transmitted from the communication device by the user,

a database of biometric measures and device identities for allowing the personal biometric measure received at the user authenticator to be related via the communication device identity to a prestored personal biometric measure of a legitimate user of the authenticable communication device, thereby to authenticate the user, and

an authentication output for producing a verifiable signal indicating successful authentication. The verifiable signal may for example be an electronic signature, or it may be a signal to a billing system or it may be a signal to enforcement units such as border control authorities.

In an embodiment, the authenticable communication device is a mobile telephone and the authenticated device identity is a caller line identification (CLI).

In an embodiment, the biometric measure is a voiceprint.

In an embodiment, the user authenticator comprises a comparator configured to compare the received personal biometric measure with a plurality of stored measures including that of the legitimate user, to determine whether that of the legitimate user has a lower delta than the other measures, thereby to authenticate the user.

In an embodiment, the user authenticator comprises a comparator configured to compare the received biometric measure with at least the prestored biometric measure of the legitimate user using at least two independent authentication algorithms, the comparator being configured to indicate successful authentication only if both of the algorithms give a positive recognition.

The system may comprise a financial transaction token, such as a cheque or a credit card or the like, wherein the authentication output is configured to provide a transaction code upon successful authentication to enable use of the token.

The transaction code may comprise an electronic signature.

In one embodiment, for the high security end of the market, the transaction code comprises an RSA cryptosystem public and private key complex.

In one embodiment, the authenticable communication device is a land line telephone and the authenticated device identity is a caller line identification (CLI) authenticated by its physical connection.

Preferably, the transaction code is associated with a time out value or specific transaction number.

According to a second aspect of the present invention there is provided a remote authentication system for authenticating remotely located users of identifiable devices, comprising:

a device authenticator for obtaining an identity of a user associated device,

a user authenticator for obtaining a personal biometric measure from voice transmitted via a communication device by the user,

a database of biometric measures and device identities for allowing the personal biometric measure received at the user authenticator to be related via the device identity to a prestored personal biometric measure of a legitimate user of the user associated device, thereby to authenticate the user, and

an authentication output for producing a verifiable signal to indicate successful authentication.

In an embodiment, the user associated device is in fact the same as the communication device and the device identity is a caller line identification (CLI).

In another embodiment, the user associated device is a transaction token such as a cheque or credit card or the like.

In an embodiment, the user associated device is a vehicle, and the system can be used for toll roads or border crossings and the like so that user authentication can be carried out on the move.

In the above embodiment, it may often happen that a plurality of users are associated with the vehicle. In the case of a toll road this does not matter. However in the case of a border crossing each user might need separate authorization. In this case each of the plurality of users having a separate prestored biometric measure associated with the vehicle in the database so that each can be authenticated individually and consequently authorized to cross the border.

In an embodiment, the biometric measure is a voiceprint. According to a third aspect of the present invention there is provided a method of remote authentication of a user, comprising:

obtaining an identity of an identifiable device,

obtaining from a database an identity of a user associated with the identifiable device,

remotely obtaining from the user a biometric measure,

comparing the obtained biometric measure with a prestored biometric measure of the associated user,

authenticating the users if the biometric measures match, and

producing a verifiable signal to indicate successful authentication.

Preferably, the biometric measure is a voice print.

In an embodiment, the comparing comprises using two independent voice print algorithms for obtaining respectively independent authentications and the authenticating requires matching by both of the algorithms.

Additionally or alternatively, the comparing comprises overcoming noise or distortion by comparing with a plurality of additional voice prints in addition to that of the associated user.

In an embodiment, the identifiable device is a telephony device and the identity is a caller line identification (CLI).

In an embodiment, the identifiable device is a mobile telephony device having a log-in procedure that includes authentication of the CLI.

In an embodiment, the identifiable device is a transaction token.

In an embodiment, the obtaining the biometric measure is carried out via a mobile telephony device having a CLI and a log-in procedure that authenticates its CLI.

In another embodiment, the identifiable device is a vehicle.

As discussed above, a plurality of users may be associated with the identifiable device and may need separate authorization, in which case they each store their voiceprints as explained.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing an authentication system according to a first preferred embodiment of the present invention;

FIG. 2 is a simplified diagram illustrating a user initiated procedure for using the system of FIG. 1, according to a preferred embodiment of the present invention;

FIG. 3 is a simplified diagram illustrating circumstances in which a center based authentication procedure may be initiated;

FIG. 4 is a simplified diagram illustrating the components of a financial transaction system according to an embodiment of the present invention;

FIG. 5 is a simplified diagram illustrating a basic financial transaction generation procedure according to the present invention;

FIG. 6 is an illustration of the process of Electronic Signature Generation according to a preferred embodiment of the present invention;

FIG. 7 is an illustration of the process of Signing a Bank Cheque according to a preferred embodiment of the present invention;

FIG. 8 is an illustration of the process of Clearing a cheque by a financial Clearinghouse, according to a preferred embodiment of the present invention;

FIG. 9 is an illustration of the process of signing a Credit Card Transaction at a Point-of-Sale, according to a preferred embodiment of the present invention;

FIG. 10 is an illustration of the process of clearing a credit card transaction at a Point-of-Sale and at a clearing entity, according to a preferred embodiment of the present invention;

FIG. 11 is an illustration of a process for cash withdrawal from an ATM, according to a preferred embodiment of the present invention; and

FIG. 12 is an illustration of a process for signing a Web-form for carrying out a web-based transaction according to a preferred embodiment of the present invention.

### DESCRIPTION OF THE PREFERRED EMBODIMENTS

The preferred embodiments provide an authentication system which makes use of the authentication technology of the mobile telephone to indicate a specific authorized user, and makes use of voiceprint technology to reliably authorize that user, preferably via the same mobile telephone. Authorization can be user initiated such as where the user wishes to authorize a transaction, or it may be center initiated, such as when entering a toll road or crossing a border. It is a feature of the preferred embodiments that no special equipment of any kind is needed at the point of authorization.

From a broader perspective a device can be identified to indicate an authorized user with a reasonable degree of certainty. The user can also authenticate himself using a biometric measure. The identification of the device and the authentication of the user work together to give a high degree of confidence to the authentication.

The principles and operation of an authentication system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

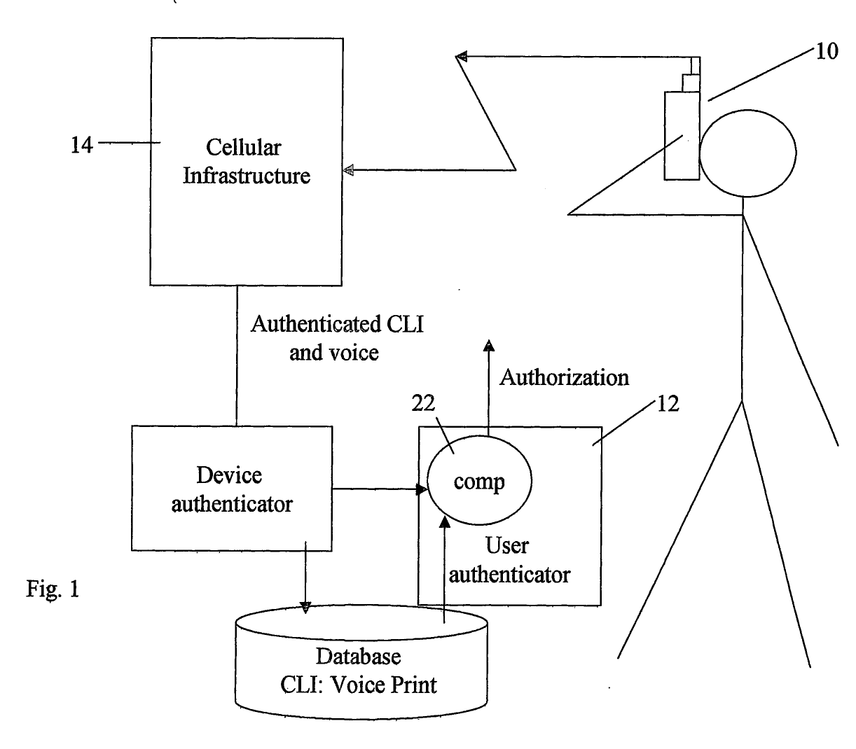

Reference is now made to FIG. 1, which illustrates a remote authentication system for authenticating remotely located users of authenticable communication devices such as a mobile telephone 10. The system comprises a device authenticator 12 for obtaining an authenticated device identity of said authenticable communication device. In the case of a mobile telephone the device identity is the caller line identification or CLI of the telephone. The CLI is authenticated as part of an electronic signature exchange which is included in mobile telephony secure log-in protocols and involves the SIM card placed in the mobile telephone. The log in authentication is carried out in any case at the mobile telephony infrastructure 14 which includes the cellular operator's base station structure, location registers and the like and is an option in the authentication process of the present embodiments. The log-in step is merely an option since the service can be provided independently of mobile telephony providers and of mobile telephones in general. SIM card based authentication is such an option. In the case of a fixed telephone a CLI is also received. There is no authentication procedure since the line identified is a physical connection, and the very physical connection represents an authentication to a certain degree. The CLI or Caller ID is the telephone number that is associated with the telephone, but, in some cases it may be suppressed by the users, often quite deliberately, since not all users are interested in letting others have notice of who is calling. In the case of caller ID suppression another unique identifier may be required from the user, such as a personal identification number (PIN) which the user may type in during the authentication process.

A device authenticator 16 receives the authenticated CLI from the mobile (or fixed) infrastructure and uses the authenticated CLI to identify the device and its associated user in database 18. Database 18 uses the CLI to obtain the prestored voice print of the authorized user of the telephone thus identified and passes the prestored voice print to user authenticator 12. The user authenticator 12 obtains a personal biometric measure, in this case the voice print, from voice transmitted from the mobile telephone along with the now authenticated CLI. Then the voice print is compared with the voice print obtained from the database and if it is concluded that they are the same then the user is positively identified and an authorization is made. The authorization may be an authorization to generate an electronic signature or other verifiable signal, as will be explained below.

There are numerous methods for obtaining a voice print from a sample of the user's voice. Furthermore there are numerous methods for comparing two voiceprints to decide whether they are the same. In particular, when using a voice sample that has been received over the cellular network the comparison method should be robust to noise and interference. In one embodiment a comparison is carried out in a comparator 22 which is configured to compare a received voiceprint with a plurality of stored voiceprints which include that of the legitimate user. A distortion is measured to each of the voice prints and the legitimate user is authenticated if his distortion is appreciably lower than any of the other voiceprints. In this method any noise in the arriving signal can be discounted since it is deltas or differences which are compared and no absolute threshold is used. The method is described in above-mentioned U.S. Pat. No. 6,510,415, the contents of which are hereby incorporated by reference.

In an alternative embodiment the comparator is configured to compare the received biometric measure with the prestored biometric measure of the legitimate user using two independent authentication algorithms. The comparator is configured to indicate successful authentication only if both of the algorithms give a positive recognition. Typically the independent algorithms principally differ in the way in which the voice print is taken. More details of the method are to be found in above-mentioned U.S. Pat. No. 5,913,196.

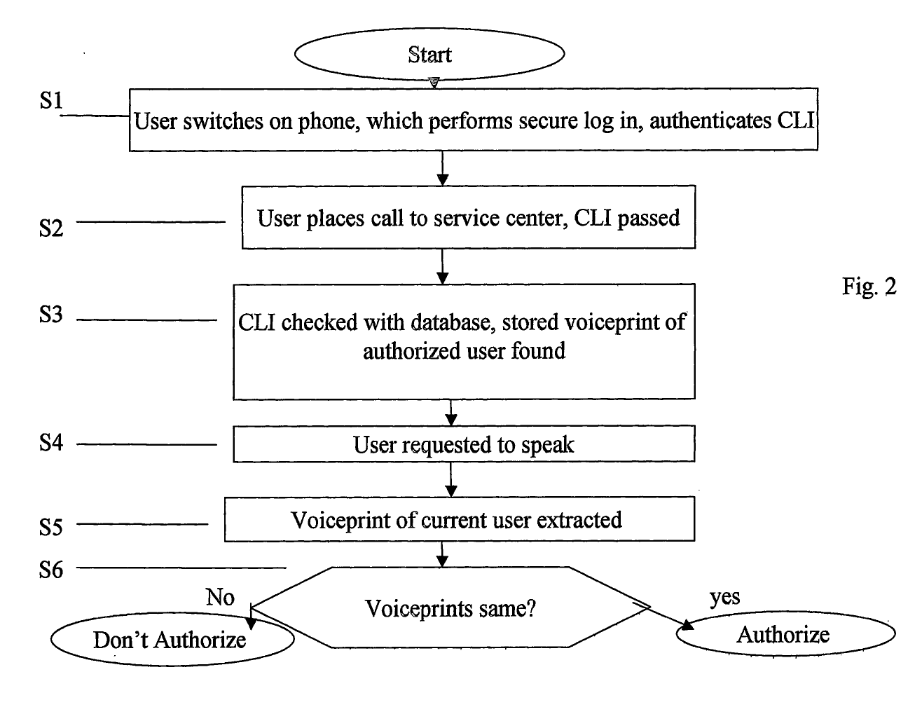

Reference is now made to FIG. 2, which is a simplified flow chart illustrating a user-initiated procedure for using the system of FIG. 1, according to a first preferred embodiment of the present invention. In FIG. 2, the process begins long before the user even considers obtaining authorization. The process in fact begins in stage S1, when the user switches on his mobile telephone and the SIM card located therein authenticates itself via the standard log on procedure. This is particularly convenient if the mobile operator is the authentication service provider. If that is not the case then the usefulness of this step depends on whether the resulting caller ID number is made available to the authentication service provider. Otherwise, as mentioned above it is necessary to require the user to enter another kind of identification information such as a PIN number. Then in stage S2, after deciding he needs authorization for any reason, the user places a call to a call center. In the process of placing the call the user's CLI is passed on, allowing the call center to identify the caller via his mobile telephone. In stage S3, the CLI is used at the database to retrieve a previously obtained voice print of the authorized user indicated as being associated with the CLI.

In stage S4, which need not follow S3 but may alternatively precede S3 or occur simultaneously therewith, the user is asked to speak into his telephone. To ensure that the session is live (i.e. to preclude the possibility that what is being heard is merely a tape-recorded voice of the legitimate user) a challenge-response session may be conducted in which the user is challenged to repeat random words. He does so and the voice is received and a voice print extracted in stage S5. The voice prints are compared in comparison stage S6, which may use any method for comparing the voice prints but the two methods outlined hereinabove in connection with FIG. 1 are preferred. If the voice prints are judged to correspond then an authorization is issued, otherwise it is not.

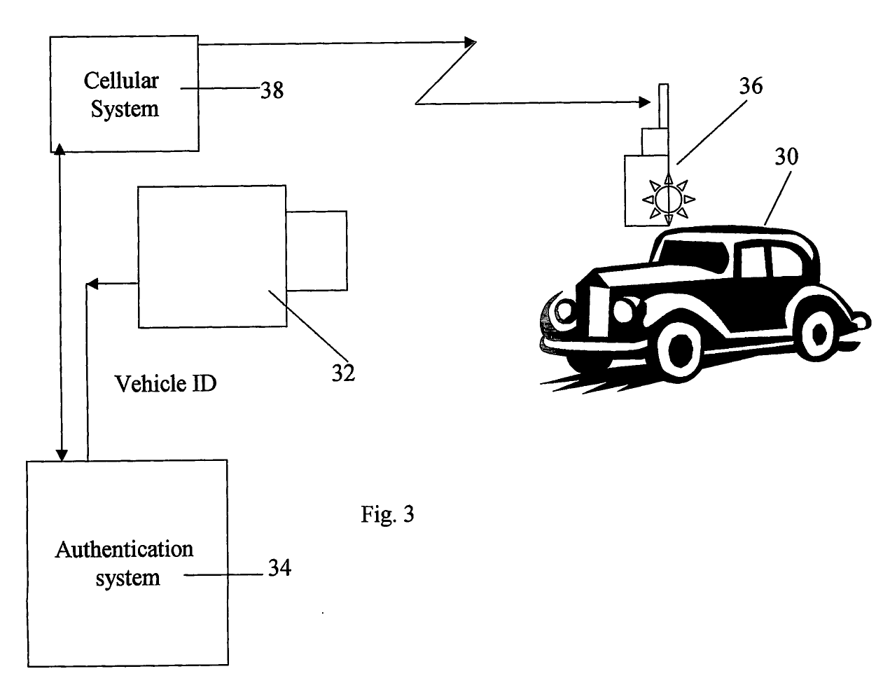

Reference is now made to FIG. 3, which is a simplified diagram illustrating an example in which a center-initiated authorization may be useful. In FIG. 3 a user travels in his car 30 and enters a restricted access road, say a toll road, a border crossing or a security zone. His car is identified, say via its registration number which is photographed by camera 32. The registration number is transferred to remote authorization system 34 which uses the registration number as a key to search a database to retrieve the CLI of the car phone 36 of the authorized user of the car 30. Alternatively a transmitter such as an RFID identifier tag may be located on the dashboard to emit a signal which is detected to identify the car. Either way the car is identified but the user is not yet authenticated. The car or other mobile telephone 36 is called via cellular system 38 which has already authenticated the CLI and an announcement is made to the user informing him that his car has been detected entering the restricted zone. He is asked to confirm that this is acceptable by speaking a given utterance into his mobile telephone. A voice print is then extracted and compared as before to carry out the authentication of the user. If the authorization is made then the user is allowed to proceed. Effective authentication is thus carried out on the move using the user's mobile telephone and his voice. Once the user has been authenticated then a signal verifying the authentication is produced to indicate that a car having the given registration number has entered the controlled zone. The signal may for example be used for billing the user in the case of a toll road, or indicating to customs at the board that the car may pass.

In the case of a border crossing it may be required to identify all of the passengers in the car as well as the driver. In the case of a speakerphone mounted in the car it is simply possible to allow each passenger to identify himself by speaking in turn. In a preferred embodiment multiple passengers are registered for the same car and the call back to the mobile telephone number is carried out multiple times—once for each verification. The number of verified persons is then equal to the number of passengers who are allowed to cross the border. The number may be indicated in the verification signal. Thus the border control authorities may receive a signal indicating that a car with a given registration is authorized to pass through with four occupants.

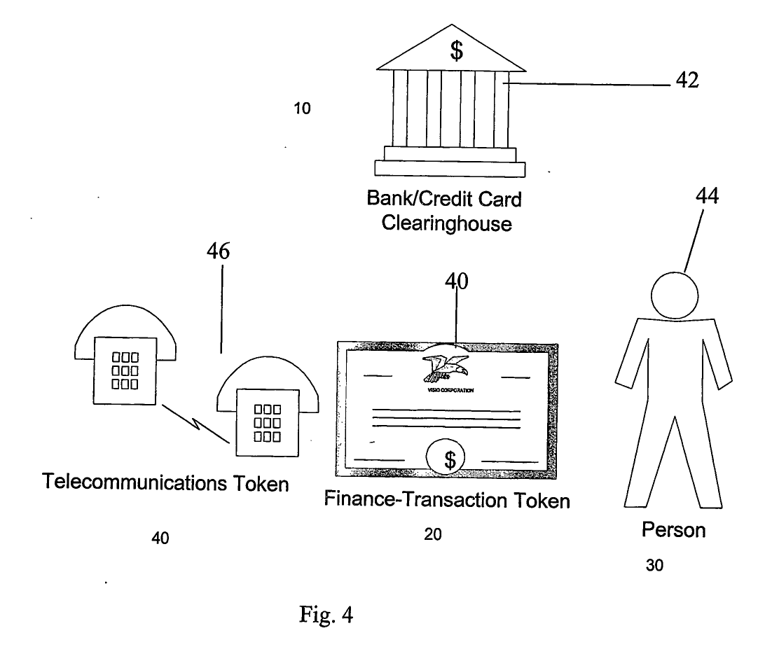

Reference is now made to FIG. 4, which illustrates preferred components for using the above-described authentication system for the authorization of a financial transaction according to preferred embodiments of the present invention. In the case of a financial transaction there is often a financial transaction token 40 such as a cheque, a credit card or the like. The authentication system itself is configured with an authorization output to provide a transaction code upon successful authentication to enable use of the token 40 and authorize the transaction. It is noted that the term “authentication” is used herein to indicate a process of verification of a person or of a device as being who they claim to be. The term “authorization” refers to a subsequent stage of permitting a transaction or the like to take place.

The authentication and authorization systems may be in the same location or in different locations, connected by a secure communication link. For example an authentication server may be located at the mobile operator and an authorization server at the bank. For simplicity of explanation in the following we merge them into a single entity which we refer to as a clearing house.

In the case of financial transactions the authorization process is provided by a financial institution such as a financial clearing house 42. The user himself 44 is required, as is a telephone connection 46, which preferably involves a mobile telephone at the user end, as described above. More specifically, the preferred components are:

Hardware.

A telecommunication token including a telephone, smart phone, VoIP phone, mobile phone, other 2-way communication devices such as radios or any other device capable of Voice communications. Preferably the telecommunication token should include its own form of authentication and thus mobile telephones are preferred.

Finance—transaction token 40 such as a credit card, personal check, or proof-of-sale slip.

An authentication and authorization server component 42 denoted as Bank/Credit Card Clearinghouse.

Software

A software module residing on authorization server 42 for authentication of Person 44, electronic signature generation, and having a persons and transactions database and able to provide authorization for transactions according to pre-determined conditions.

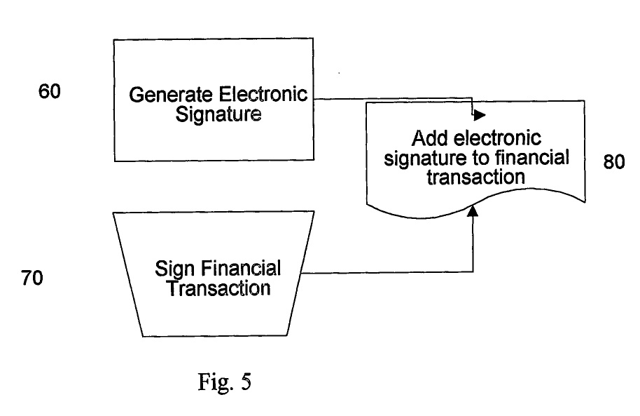

Reference is now made to FIG. 5, which is a simplified illustration of a basic transaction process according to preferred embodiments of the present invention including generation of the electronic signature by the user 44 using communication token 40 and his mobile phone, resulting in authentication as described above. Following authentication he obtains an authorization. Using the authorization he is able to carry out the financial transaction using the transaction token 40. He may be required to add the electronic signature to the transaction token, as will be explained in more detail below.

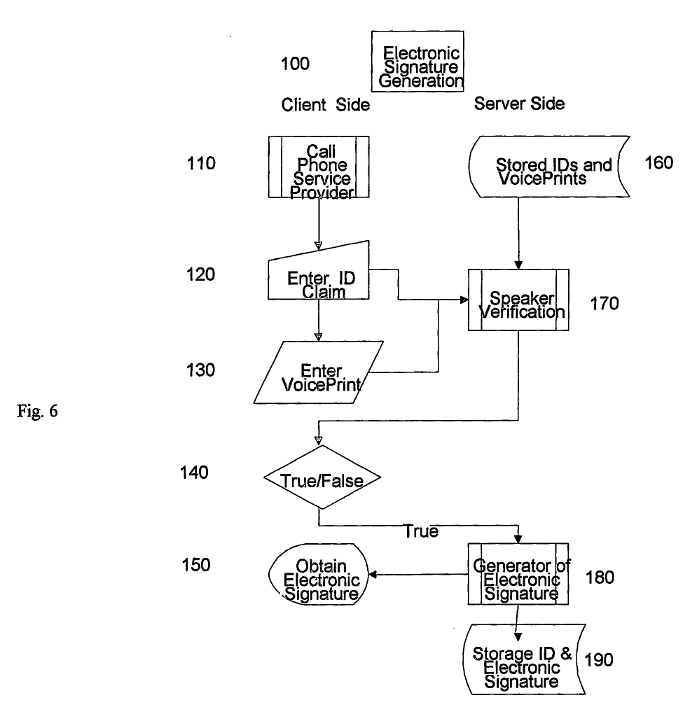

In order to obtain an authorization code or electronic signature, an authorization procedure as described above in respect of FIGS. 1 and 2 is required. Referring now to FIG. 6, in order to obtain an electronic signature, user 42 firstly calls Clearing house 10, possibly using a toll-free number, in stage 110.

Preferably the CLI is recognized, using the standard Caller ID function of Telecommunication token 40, as being that of a valid user, as described above. It is pointed out that all telephones have a caller ID number, not just mobile telephones. However mobile telephones have a log-in procedure that includes authentication, which can be taken advantage of, as explained above.

The Consumer is then prompted to enter his PIN (Personal Identification Number) either verbally (to be recognized using Speech Recognition) or using DTMF touch-tones in stage 120. it is noted that this stage is optional. For example if the CLI is available and there is only one user associated with the device, then this stage is unnecessary. Alternatively it can be insisted on nevertheless, in order to add an extra layer of security.

Although any Biometrics verification can be performed in conjunction with the present embodiment—Voice-scan and voice prints have the advantage of being intrinsically built in to voice communication devices and thus do not require any additional hardware. Thus the specific embodiments discussed herein refer to voice Authentication, that is speaker verification. The Consumer is prompted in stage 130 to perform voice authentication in stage 170. As already discussed, preferred methods for Speaker Verification are described in U.S. Pat. Nos. 5,913,196 and 6,510,415.

In one preferred embodiment, stages 120 and 130 are merged and the voice print is obtained directly from the user verbally entering a pin number, that is to say it is possible to combine Speech Recognition and Speaker Verification.

If Voice Authentication is successful 140—Clearing house 10 then generates an electronic signature in stage 180. The user receives a transaction authorization number or electronic signature 150. The electronic signature may include alphanumeric characters and its length may be chosen to suit the precise application, user convenience and operational requirements such as security, storage, etc.

The Electronic Signature is preferably also sent to database storage 190, located within the Clearinghouse 10, for future retrieval in conjunction with personal information of the individual user.

In one embodiment, the electronic signature may be sent to the user in verbal form. In another embodiment it may be sent using SMS or email. In yet another embodiment, the signature may be delivered as a data file. The user may write down the Electronic Signature or store it electronically for future use.

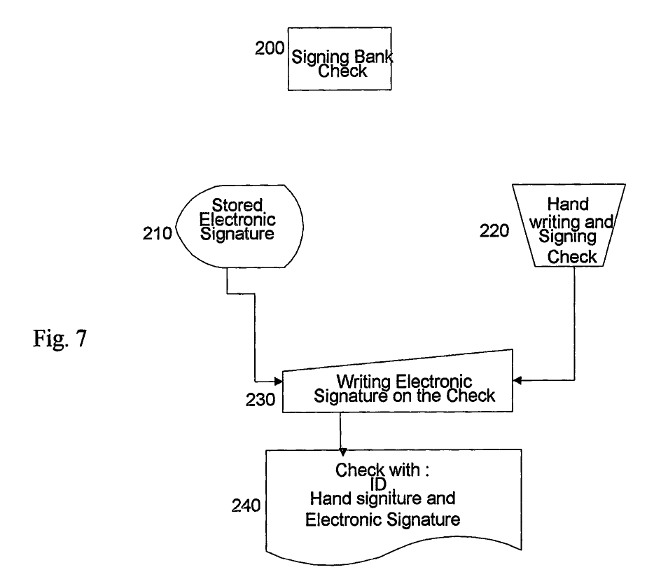

In some kinds of financial transaction the user may wish to physically sign the token, for example in the case of a cheque. The procedure is illustrated in FIG. 7. The user calls the Clearinghouse service. The CLI is recognized, and then he enters PIN and Voice and, preferably, the cheque identification number to identify further the Transaction. He then receives a Transaction Authorization number or Electronic Signature, which he writes on the cheque.

Referring to FIG. 7 the user adds 230 the electronic signature he has been provided with, stage 210, on the Cheque in addition to his signature provided in stage 220. That is to say the Cheque now carries two signatures—a personal signature and the electronically provided authorization code, leading to the state illustrated in stage 240.

A validity check of the electronic signature may then be based upon pre-determined conditions at the Clearinghouse, for example, the electronic Signature is attached to a token of a known transaction, described, for example by a cheque identification number, etc.

There are two kinds of conditions that may be applied to electronic signatures:

1. The electronic signature may expire after a pre-determined time period, for example 1 hour or 1 day. Thus the user is free to use the same authorization code for any number of transactions carried out in that time period.

2. Alternatively a given electronic signature may be valid for use only once. This may be irrespective of the transaction number or time period, or it may be restricted to a certain time period and transaction type, or any other combination deemed appropriate.

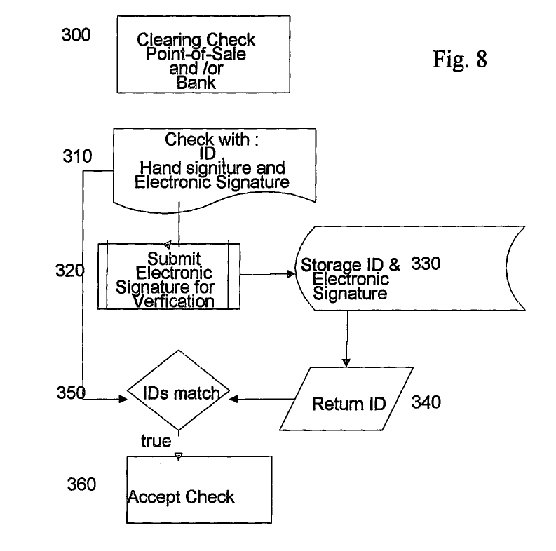

At a later stage the clearing house—in this case a bank—receives the cheque. The bank checks the Transaction Authorization Number (Electronic Signature) for validity. The bank receives the check number and if that is valid it receives the name of the signer, that is the user who was authenticated and for whom authorization was provided. If the names match those on the cheque—then the cheque is authorized. The authentication procedure is illustrated in FIG. 8. Clearing house 10 receives the cheque 310 with both the personal (hand) signature and the electronic signature. Electronic Signature is submitted for verification vis a vis a storage database 330 and if the identities match 340 then the cheque is cleared in stage 350. A merchant at the point-of-sale can himself make the same validation before accepting the cheque.

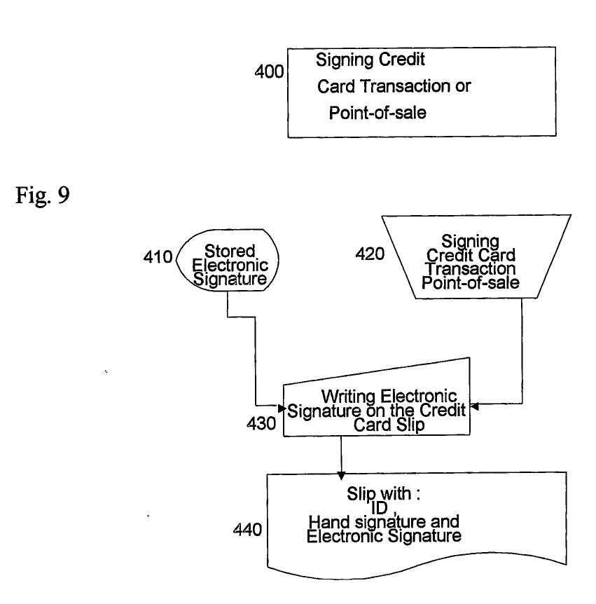

In many circumstances the bank also requires the identification of the Person to whom the cheque is to be paid. The procedure is illustrated in FIG. 9. If such a person signs on the back of the cheque with his Electronic Signature—the bank is able to verify the payee's identity before cash is paid.

Referring now to FIG. 9, the payee, in stage 430, adds Electronic Signature 410 on the Credit Card Slip 420 or on the back of the cheque as appropriate, in addition to his signature, namely the token is signed with two signatures—personal and electronic 440 as before. In the Point-of-Sale scenario for a high-value transaction the merchant may request that the consumer obtains the Electronic Signature in front of him and thus verifies the ID of the user in real-time, by receiving the authorization. Thus the system of the present embodiments may serve as a real-time transaction authorization, and since no specialized equipment is involved, it can be carried out anywhere at any time. Thus a high value sale can be made immediately and in a secure manner say during a meeting held at a neutral location.

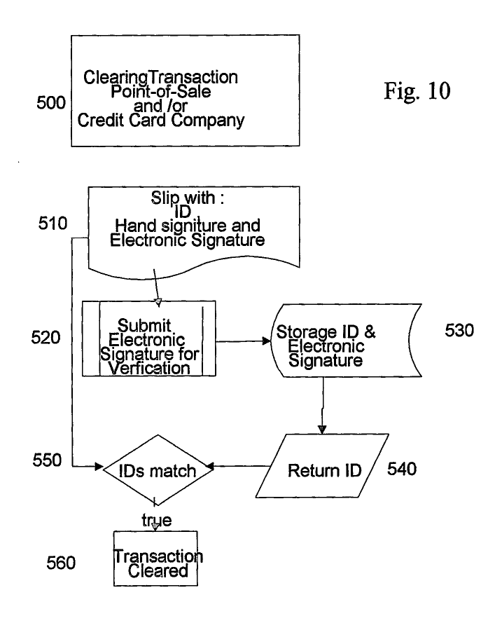

Reference is now made to FIG. 10 which shows the procedure later on at the bank etc for clearing the transaction. The clearing house or bank 10 receives the credit card slip 510 with the personal (hand) signature and Electronic signature, as before. Electronic Signature 520 is verified vis a vis storage 530 and if the identities match 550—then the slip and corresponding transaction is cleared in stage 560.

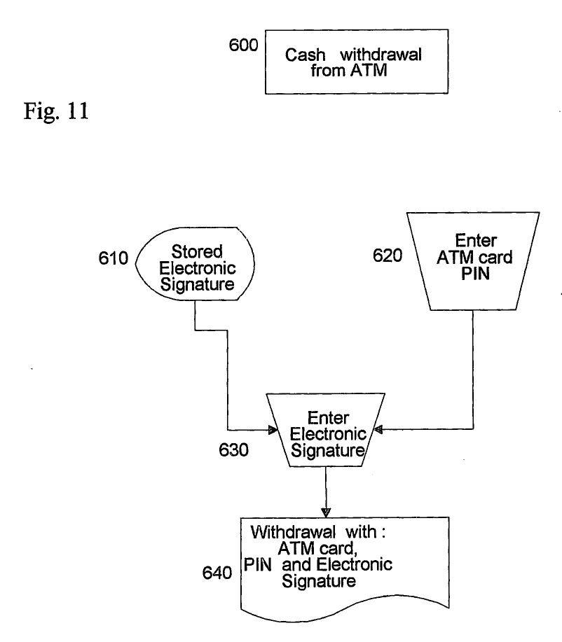

In another embodiment the Consumer wishes to withdraw cash from an ATM. He inserts his credit card, and enters both a PIN number and his Electronic Signature. If all three are valid then the money is dispensed. The procedure is illustrated in FIG. 11. A previously obtained electronic signature 610 is entered 630 alongside the Credit card itself and the Personal Identification Number (PIN) 620 during cash withdrawal 640.

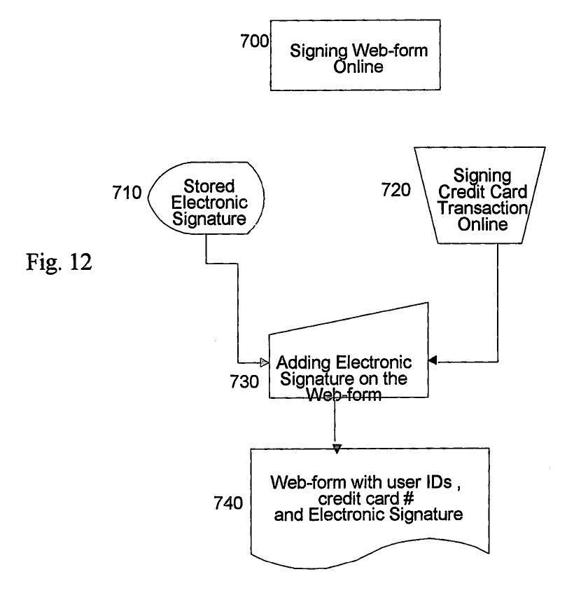

In another embodiment the Consumer wishes to carry out an Internet transaction. In this case he enters his credit card number, and also enters his PIN and his Electronic Signature. If all three are valid—the transaction proceeds. Referring now to FIG. 12, stored electronic signature 710 is added 730 to Web-based (online) credit card 720 transactions 740.

In yet another embodiment—the Electronic Signature may be entered by the Consumer automatically using Automatic Data Transfer via a Communication Port. An example is the Infrared Communication Port or BlueTooth available on state-of-the-art mobile telephones. Another example is a suitable reader or receivers on a point-of-sale machine, an ATM and at a bank.

In many of the above embodiments it has been assumed that the electronic signature is a short numerical or alphanumeric code suitable for user manipulation. Thus the user is able to insert the code on the back of a cheque etc. However, once computer systems are involved, as for example in the embodiment of FIG. 11, for greater security, the code can be in a form that requires a computer to handle it. Thus the user may be provided with a signature based on the RSA cryptosystem. The RSA cryptosystem provides a complex of one public and _one private key, which together can be used for electronic signing of documents. However the keys are of the order of magnitude of a hundred digits long and thus require computerized handling.

It is expected that during the life of this patent many relevant devices and systems will be developed and the scope of the terms herein, particularly of the term “electronic signature” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A remote authentication system for authenticating remotely located users of authenticable communication devices, comprising:
a device authenticator for obtaining an authenticated device identity of said authenticable communication device,
a user authenticator for obtaining a personal biometric measure from voice-transmitted from said communication device by said user,
a database of biometric measures and device identities for allowing the personal biometric measure received at the user authenticator to be related via the communication device identity to a prestored personal biometric measure of a legitimate user of said authenticable communication device, thereby to authenticate said user, and
an authentication output for producing a verifiable signal indicating successful authentication.

2. The remote authentication system of claim 1, wherein said authenticable communication device is a mobile telephone and said authenticated device identity is a caller line identification (CLI).

3. The remote authentication system of claim 1, wherein said biometric measure is a voiceprint.

4. The remote authentication system of claim 1, wherein said user authenticator comprises a comparator configured to compare said received personal biometric measure with a plurality of stored measures including that of said legitimate user, to determine whether that of said legitimate user has a lower delta than said other measures, thereby to authenticate said user.

5. The remote authentication system of claim 1, wherein said user authenticator comprises a comparator configured to compare said received biometric measure with at least said prestored biometric measure of said legitimate user using at least two independent authentication algorithms, said comparator being configured to indicate successful authentication only if both of said algorithms give a positive recognition.

6. The remote authentication system of claim 1, further comprising a financial transaction token, wherein said authentication output is configured to provide a transaction code upon successful authentication to enable use of said token.

7. The remote authentication system of claim 6, wherein said transaction code comprises an electronic signature.

8. The remote authentication system of claim 6, wherein said transaction code comprises an RSA cryptosystem public and private key complex.

9. The remote authentication system of claim 1, wherein said authenticable communication device is a land line telephone and said authenticated device identity is a caller line identification (CLI) authenticated by its physical connection.

10. The remote authentication system of claim 6, wherein said transaction code is associated with a time out value or specific transaction number.

11. A remote authentication system for authenticating remotely located users of identifiable devices, comprising:
a device authenticator for obtaining an identity of a user associated device,
a user authenticator for obtaining a personal biometric measure from voice transmitted via a communication device by said user,
a database of biometric measures and device identities for allowing the personal biometric measure received at the user authenticator to be related via the device identity to a prestored personal biometric measure of a legitimate user of said user associated device, thereby to authenticate said user, and
an authentication output for producing a verifiable signal to indicate successful authentication.

12. The remote authentication system of claim 11, wherein said user associated device is also said communication device and said device identity is a caller line identification (CLI).

13. The remote authentication system of claim 11, wherein said user associated device is a transaction token.

14. The remote authentication system of claim 11, wherein said user associated device is a vehicle.

15. The remote authentication system of claim 14, wherein a plurality of users are associated with said vehicle, each of said plurality of users having a separate prestored biometric measure associated with said vehicle in said database.

16. The remote authentication system of claim 11, wherein said biometric measure is a voiceprint.

17. A method of remote authentication of a user, comprising:
obtaining an identity of an identifiable device,
obtaining from a database an identity of a user associated with said identifiable device,
remotely obtaining from said user a biometric measure,
comparing said obtained biometric measure with a prestored biometric measure of said associated user,
authenticating said users if said biometric measures match, and
producing a verifiable signal to indicate successful authentication.

18. The method of claim 17, wherein said biometric measure is a voice print.

19. The method of claim 18, wherein said comparing comprises using two independent voice print algorithms for obtaining respectively independent authentications and said authenticating requires matching by both of said algorithms.

20. The method of claim 18, wherein said comparing comprises overcoming noise or distortion by comparing with a plurality of additional voice prints in addition to that of said associated user.

21. The method of claim 18, wherein said identifiable device is a telephony device and said identity is a caller line identification (CLI).

22. The method of claim 21, wherein said identifiable device is a mobile telephony device having a log-in procedure that includes authentication of said CLI.

23. The method of claim 18, wherein said identifiable device is a transaction token.

24. The method of claim 23, wherein said obtaining said biometric measure is carried out via a mobile telephony device having a CLI and a log-in procedure that authenticates its CLI.

25. The method of claim 18, wherein said identifiable device is a vehicle.

26. The method of claim 18, wherein a plurality of users are associated with said identifiable device.
